(19) United States
(12) Patent Application Publication
(10) Pub. No.: US 2019/0363642 A1
(43) Pub. Date: Nov. 28, 2019

(54) Inverter

(71) Applicant: Fuxiang Lin, Lidcombe (AU)

(72) Inventor: Fuxiang Lin, Lidcombe (AU)

(73) Assignee: Fuxiang Lin, Lidcombe (AU)

(21) Appl. No.: 15/987,880

(22) Filed: May 23, 2018

(51) Int. Cl. H02M 7/48; H02M 3/158

(52) U.S. Cl. CPC H02M 7/48; H02M 3/1582

(57) ABSTRACT

A buck inverter uses an input current signal compares an output current signal generated from a resistor and generates a control signal to control buck circuit switch and forces the output current follow a waveform of the input current signal. The input current signal can be generated by AC power system through a certain circuit or by a microcontroller or a waveform generator circuit. It is simple, highly efficient and low cost, because it does not use IGBT components and only uses mosfets and low inductance value of inductors.

### FIELD OF INVENTION

It is related to the DC to AC converter, particular in the field of the DC power converted to a commercial AC power in simple and high efficient method.

### BACKGROUND OF THE INVENTION

The inverters are the converters that transform a DC power into an AC power. There traditionally are two kind inverter topologies, one is that inverter's output and inverter's input are isolated, the other is that inverter's output and inverter's input are not isolated. The isolated inverter is very popular used in UPS system, but it has drawbacks in an efficiency and an cost. The non-isolated in inverter is developed in recent years and it is getting popular in solar power system. This topology is consist of a boost stage and a choke stage. The boost stage is used to boost an input voltage to an level above the peak value of the AC output voltage. The choke stage is used to limited output current to the sine-waveform. The choke stage uses IGBT components to perform chopping task and IGBT is slow responding component compared to a mosfet component and this will result in high loss in switching on and off period. To improve the efficiency of the inverter, it has to simplify the circuit and to use a fast responding component, this invention is proposed to overcome above problem.

### SUMMARY OF THE INVENTION

An inverter is designed to using fast components to prevent the switching loss. If an input DC power is above a peak value of an AC power; a buck circuit is applied to control an output current to a half sine waveform, a full bridge circuit is used to transforms an half sine waveform DC current into an AC current. If the input voltage is lower than the peak value of the AC power, a boost circuit is used to boost the input voltage of the DC power into DC power that its voltage is above the peak value of the AC voltage of the AC power then the buck circuit is used to transforms this DC power into an AC power or a buck boost circuit to transform DC power into an AC power. If there are a high voltage of an input DC power (a voltage above the peak voltage value of the AC power) and a low voltage of an input DC power (a voltage below the peak voltage value of the AC power), two buck circuits is used to transforms the two DC power into an AC power. It can be a DC power that a voltage below the peak voltage value of an AC power, then a boost circuit is used to boost the input power into a high voltage DC power, so there are two voltage DC power, one is the original DC power; the other is the boosted DC power. It applied control method to buck circuit to transform DC power into half sine waveforms by using a pseudo signal to let an output current follow the pseudo signal.

### BRIEF DESCRIPTION OF THE DRAWINGS

FIG. 1 is a traditional non-isolated inverter topology.

FIG. 2 is one of the invention topology, buck circuit inverter.

FIG. 3 is another of the invention topology, buck and buck circuit inverter.

FIG. 4 is yet another of the invention topology, buck boost circuit inverter.

FIG. 5 is a buck circuit.

FIG. 6 is another buck circuit.

FIG. 7 is a boost circuit.

FIG. 8 is a pseudo signal generator.

FIG. 9 is a simulation current waveform of a 1000 w buck inverter (before a full bridge circuit).

FIG. 10 is a simulation current waveform of a 500 w buck boost inverter (before a full bridge circuit).

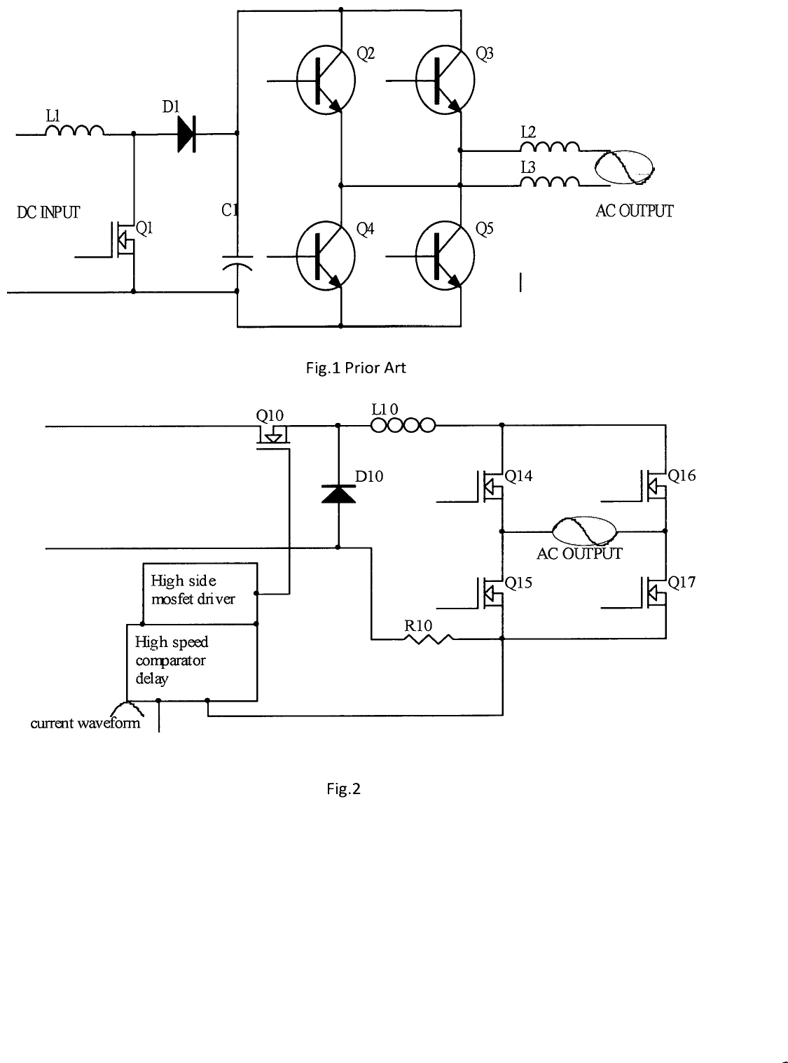

### DETAIL OF THE INVENTION

Before description it should be understood that this invention uses comparator to compare an input current with an output current then to generate control a signal to control a buck circuit switch and to force the output current following a waveform of the input current. A circuit that transform DC power to AC power by using this idea can be applied in different circuit arrangements. The invent circuits are examples of this idea, by using this idea, it can develop different circuit diagram. It should be including in this invention.

### An Inverter (FIG. 2)

The inverter is composed by buck circuit, a full bridge switches circuit and a control circuit. A buck circuit includes a first switch Q10, a first diode D10 and an inductor L10. The bridge switch circuit includes four switches Q14, Q15, Q16 and Q17 and a resistor.

The buck circuit connection, the first switch Q10 and the first inductor L10 are connected in series the first switch terminal is connected to the positive terminal of a DC input source such as a battery or a solar power or a voltage source boosted from the battery or solar power. The inductor terminal is a buck circuit output terminal. An anode of the first diode D10 is connected to a negative terminal of the input DC source as buck circuit's negative input or output terminal, the cathode of the first diode is connected to the first inductor and the first switch.

The bridge switch circuit, a fourth switch Q14 and a fifth switch Q15 are connected in series, one end of this series circuit is connected to the positive output of the buck circuit, the other end of this series circuit is connected to a resistor R10, the resistor R10 is connected to the negative output of the buck circuit, A sixth switch Q15 and a seventh switch Q16 are connected in series, a terminal of the sixth switch Q15 is connected to the positive output of the buck circuit and a terminal of the seventh switch Q16 is connected to a resistor R10.

A control circuit of the buck circuit includes a comparator, a mosfet drivers. The comparator compares an output current voltage and an input current voltage and output a signal with a delay period to the mosfet driver that drives the first switch on or off.

### The Operation of the Invention Circuit

When an input current is lower than an output current, the comparator output a low signal to keep the first switch Q10 in non-conduction condition, when the input current is higher than the output current, the comparator outputs a signal to the mosfet driver to turn on the switch Q10 of the buck circuit, a current from the voltage source to a load of an AC power system and it keeps on until the comparator sends a signal to mosfet driver to turn it off. When the input current is lower than the output current, the comparator sends a signal to the mosfet driver to turn the switch Q10 off and an energy stored in the first inductor L10 releases its energy through the first diode D10 to the load. The buck circuit keeps its operation according to the condition of the input current and the output current. The first inductor L10 is designed to its circuit best performance, the increasing in the value of the inductor L10, decreasing a frequency of a turn on and off of the first switch Q10.

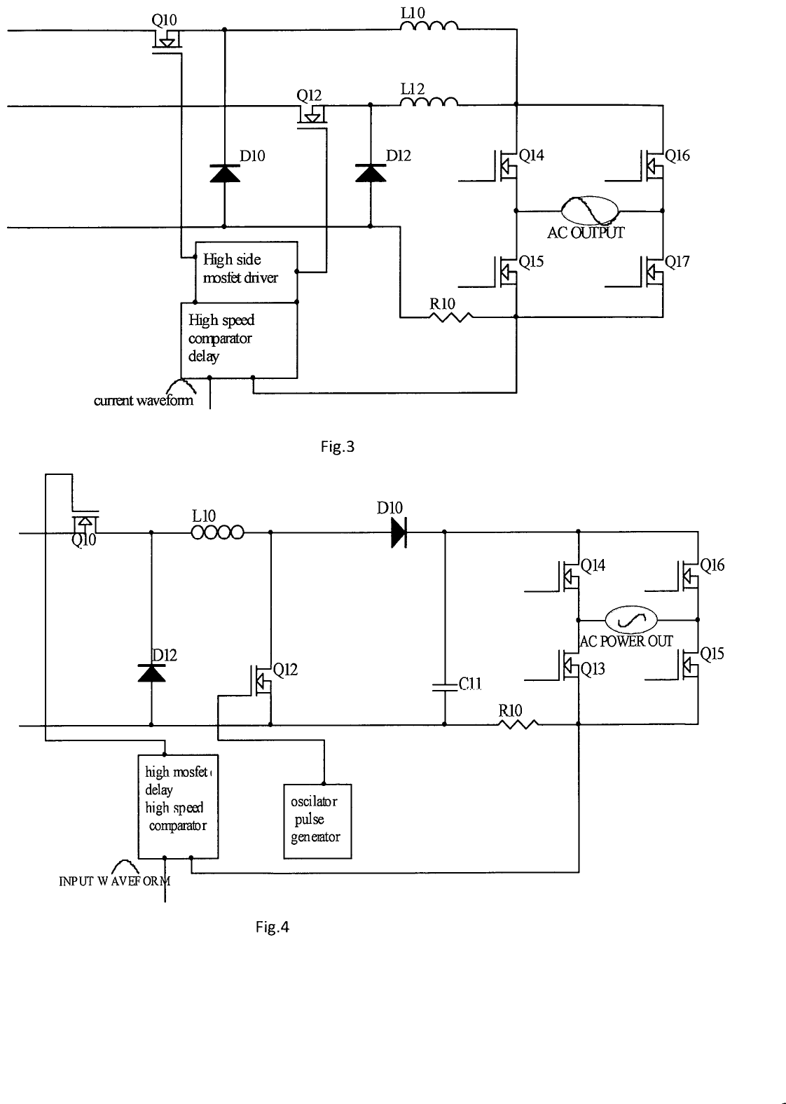

FIG. 3 is buck and buck inverter, its operation as following:

When An AC output voltage is higher, a high voltage source's buck circuit operates. When the AC output voltage is lower a bit than a low voltage source, a low voltage source's buck circuit.

FIG. 4 is buck boost inverter, its operation as following:

When an output voltage of an AC power is higher, when an input current is lower than an output current, a buck switch Q10 is off. When the input current is high than the output current, the comparator outputs a signal to the mosfet driver to turn on the switch Q10 of the buck circuit, the boost circuit boosts the voltage source's voltage to a voltage of the output AC power, a current from the voltage source through the first switch Q10 and a second diode D10 to a full bridge circuit and to a load of an AC power system and the switch Q10 is kept on until the comparator sends a signal to mosfet driver to turn it off. When the input current is lower than the output current, the comparator sends a signal to the mosfet driver to turn the switch Q10 off and an energy stored in the first inductor L10 releases its energy through the first diode D12 and the second diode D10 to a full bridge circuit and to a load of an AC power system. The buck boost switches keep their operation according to the condition of the input current and the output current. When an output voltage of an AC power is a bit lower than an input voltage, the second switch Q12 is off, the buck switch Q10 operates according to the condition of the input current and the output current.

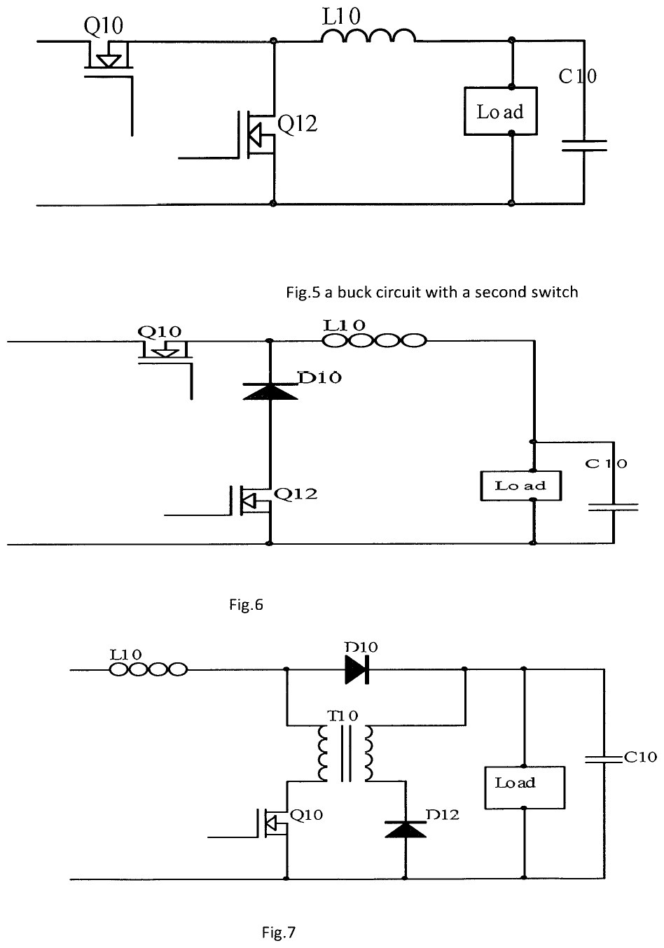

FIG. 5 is a buck circuit, using switch Q12 to replace diode D10 preventing reserve current of diode D10 through switch Q10.

FIG. 6 is a buck circuit, using switch Q12 connected diode D10 to replace diode D10 preventing reserve current of diode D10 through switch Q10, preventing a reserve current through the switch Q12 when there no energy stored in the inductor L10 but the switch Q12 is on.

FIG. 7 is a boost circuit by employing a transformer in a boost circuit to prevent reserve current through a diode D10 and a switch Q10 when the switch Q10 is turn off.

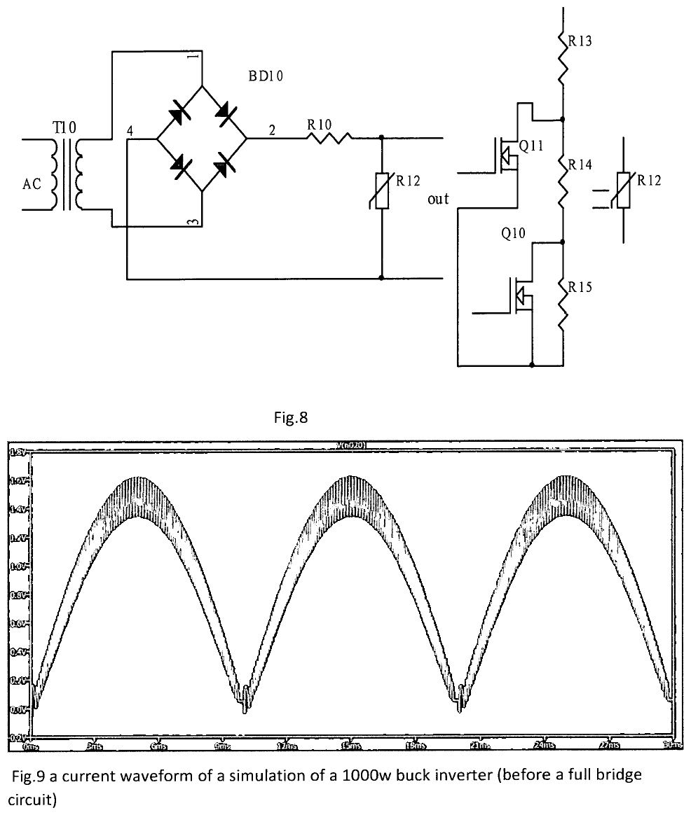

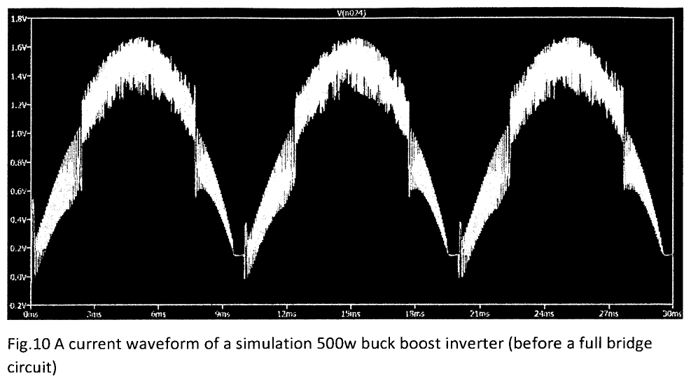

FIG. 8 is an example of a signal generator using AC power to generate an appropriate signal by turn on/off switches Q10, Q11.

What is claimed:

1. An inverter is composed of an AC to DC converter, a resistor and its switch's control circuit.

2.-14. (canceled)

15. The inverter according to the claim 1, wherein the switch's control circuit is composed of a comparator, a delay circuit, a switch driver, a output current sensor (resistor) and a pseudo signal.

16. The inverter according to the claim 15, wherein the comparator compares a pseudo signal with an output current signal of the inverter which generates from the output current sensor (resistor); when the pseudo signal is higher than the output current signal of the inverter, the comparator outputs a turn on signal and this turn on signal passes through the delay circuit with a period delay time to the switch driver which turns on switches in the inverter; when the pseudo signal is lower than the output current signal of the inverter, the comparator outputs a turn off signal and this turn off signal passes through the delay circuit to the switch driver which turns off the switches in the inverter.

17. The inverter according to the claim 15, wherein the delay circuit is used to decrease the switching frequency and to reduce power loss in switching.

18. The inverter according to the claim 15, wherein the pseudo signal is generated by an AC power system or by a microcontroller or by a waveform circuit generator.

19. The inverter according to the claim 15, wherein the comparator compares a output signal with the pseudo signal (sine signal) output a switching signal through a delay circuit to a switch driver which controls a switch on or off and the movements of the switch's on or off force the inverter's output current following the pseudo signal (sine signal).

20. The inverter according to the claim 15, wherein the pseudo signal is used to control the output power of the inverter; by adjusting the amplitude of the pseudo signal, it adjusts the output power of the inverter.
